(19) United States
(12) Patent Application Publication
(10) Pub. No.: US 2022/0075031 A1
(43) Pub. Date: Mar. 10, 2022

(54) LIDAR RECEIVER UNIT

(71) Applicant: Robert Bosch GmbH, Stuttgart (DE)

(72) Inventor: Johannes Richter, Ludwigsburg (DE)

(21) Appl. No.: 17/446,798

(22) Filed: Sep. 2, 2021

(30) Foreign Application Priority Data
Sep. 4, 2020 (DE) 102020211156.1

(51) Int. Cl. G01S 7/481; G01S 7/48

(52) U.S. Cl. CPC G01S 7/4813; G01S 7/497; G01S 7/4804

(57) ABSTRACT

A LIDAR receiver unit for detecting laser light in the surroundings of the LIDAR receiver unit. The LIDAR receiver unit includes a detector surface and a test-light illumination unit immovably situated with respect to the detector surface.

The test-light illumination unit is designed for illuminating the detector surface in order to simulate background light.

### CROSS REFERENCE

The present application claims the benefit under 35 U.S.C. § 119 of German Patent Application No. DE 102020211156.1 filed on Sep. 4, 2020, which is expressly incorporated herein by reference in its entirety.

### FIELD

The present invention relates to a LIDAR receiver unit. The present invention also relates to a LIDAR sensor including such a LIDAR receiver unit. The LIDAR receiver unit advantageously makes it possible to carry out optimized self-tests.

### BACKGROUND INFORMATION

In the related art, vehicles traveling, in particular in an automated manner, may include LIDAR sensors in order to scan surroundings. Such LIDAR sensors are checked on the basis of a plurality of function tests, all these tests being dependent on environmental influences such as, in particular, background light. In order to be able to carry out an optimal test, a background light intensity is necessary in laboratory tests, which is comparable to the background light intensities that exist in the real world. The background light in the real utilization of the LIDAR sensor is usually generated by sunlight.

In addition, it is advantageous, specifically in autonomously driving vehicles, that LIDAR sensors regularly carry out self-tests. Conventionally, the output power of a laser light source of the LIDAR sensor is regularly checked, in order to ensure a stable output power over the service life of the LIDAR sensor.

### SUMMARY

A LIDAR receiver unit according to an example embodiment of the present invention makes it possible to carry out self-tests in a simple and cost-effective way. For this purpose, it is made possible, on the one hand, to optimally simulate background illumination; on the other hand, a function test of the receiver itself may also be easily and with little complexity carried out. For this purpose, an additional test-light illumination unit is provided, which is fixedly installed in the LIDAR receiver unit and which, in an advantageous way, allows for the simulation of background light.

The LIDAR receiver unit is utilized for detecting laser light in surroundings of the LIDAR receiver unit. In particular, the

LIDAR receiver unit is part of a LIDAR sensor, which emits laser light into the surroundings, so that the LIDAR receiver unit may detect the laser light reflected by the surroundings. The LIDAR receiver unit includes a detector surface, the detector surface advantageously being a two-dimensional arrangement of multiple pixels. A detected quantity of light may therefore be determined on the basis of the pixels.

Moreover, a test-light illumination unit is provided, which is immovably situated with respect to the detector surface. The test-light illumination unit is designed for illuminating the detector surface in order to simulate background light. No additional measures are necessary, in order to simulate a background illumination. Rather, the LIDAR receiver unit itself already includes an appropriate light source, which may simulate a background light intensity. Preferably, it is therefore provided that a small spatial distance is present between the test-light illumination unit and the detector surface, so that an optimal simulation of real background light conditions may already take place at low light intensities from the test-light illumination unit. The test-light illumination unit is designed, in particular, for illuminating the entire detector surface. It is also preferably provided that the test-light illumination unit emits light directed onto the detector surface, so that an illumination of areas next to the detector surface is preferably prevented. Therefore, a targeted illumination of the detector surface may be achieved, as the result of which only low light intensities need to be emitted from the test-light illumination unit.

In accordance with an example embodiment of the present invention, if a function test of a LIDAR sensor is carried out, which includes a LIDAR receiver unit as described above, the test-light illumination unit is merely to be activated, in order to simulate background light. Therefore, function tests may be easily and with little complexity carried out. A repeated execution of such function tests is therefore also easily and with little complexity made possible. The test-light illumination unit is advantageously deactivated during the normal measuring operation of the LIDAR sensor.

Preferred refinements of the present invention are disclosed herein.

Preferably, it is provided that the LIDAR receiver unit includes at least one optical element. The optical element is preferably a part of an entire objective lens. The at least one optical element is designed for imaging the surroundings onto the detector surface. In this way, the detector surface is advantageously enabled to detect laser light from the surroundings. On the basis of the above-described, advantageously present pixels, a spatial assignment of the detected laser light may be effectuated. The test-light illumination unit is advantageously situated between the particular positions of the detector surface and the optical element with respect to an optical axis, which extends from the optical element to the detector surface. It is particularly advantageously provided that the test-light illumination unit is offset with respect to the optical axis between the optical element and the detector surface, so that no influencing or shielding of laser light, which extends from the optical element to the detector surface, takes place. Due to the placement of the test-light illumination unit between the detector surface and the optical element, the above-described close spatial arrangement between the detector surface and the test illumination unit is therefore advantageously implemented. Therefore, the test-light illumination unit is highly advantageously located.

Particularly advantageously, in accordance with an example embodiment of the present invention, it is provided that the test-light illumination unit is designed for illuminating the at least one optical element. On the basis of a reflection of the test light emitted from the test-light illumination unit, an indirect illumination of the detector surface therefore takes place, since aforementioned test light is reflected by the optical element. Therefore, the optical element is designed for illuminating the detector surface by reflecting the light of the test-light illumination unit. In this way, a highly homogeneous light distribution on the detector surface may be achieved with the aid of the test light. As a result, an advantageous simulation of background light is achieved.

Particularly advantageously, in accordance with an example embodiment of the present invention, it is also provided that the at least one optical element includes an anti-reflection coating at least on a side facing the detector surface. A wavelength, for which the anti-reflection coating is effective, is preferably different from the wavelength of the light emitted from the test-light illumination unit. Therefore, the anti-reflection coating is advantageously effective only for the laser light detected from the surroundings. Therefore, the anti-reflection coating advantageously suppresses only reflected laser light, but not reflections of the light emitted from the test-light illumination unit.

In one alternative embodiment of the present invention, the test-light illumination unit is preferably designed for directly illuminating the detector surface. Therefore, the test-light illumination unit is advantageously oriented in such a way that emitted light may directly reach the detector surface without additional reflection. In this way, losses are minimized, so that an optimal simulation of background light may take place using very little light power, which is to be output by the test-light illumination unit.

Preferably, it is also provided that the LIDAR receiver unit includes a housing. The detector surface, on the one hand, is situated in the housing; on the other hand, the test-light illumination unit is fastened in the housing. Therefore, the above-described, advantageous immovable placement of the test-light illumination unit in relation to the detector surface is implemented. The housing additionally includes an opening, through which the laser light from the surroundings is detectable by the detector surface. The above-described, advantageous optical element is preferably present in the aforementioned opening. Therefore, the above-described, advantageous placement of the test-light illumination unit between the detector surface and the opening is also easily and with little complexity implemented. Due to the fastening of the test-light illumination unit at the housing, it is also achievable that the test-light illumination unit does not interfere with an optical path of the laser light between the opening or the optical element and the detector surface and, thereby, has no effect on the normal measuring operation of the LIDAR sensor.

The test-light illumination unit preferably includes multiple individual light sources. The individual light sources are situated at different positions around the detector surface and are utilized for illuminating the detector surface from different directions. In this way, a homogeneous light distribution on the detector surface may be achieved, so that a high-quality simulation of background light may be carried out.

In one further preferred embodiment of the present invention, the test-light illumination unit is designed to be dimmable. Therefore, a light intensity of the simulated background light may be adjusted. Particularly advantageously, the dimming takes place steplessly, so that variable background light conditions are simulatable.

The test-light illumination unit preferably includes at least one light-emitting diode. The light-emitting diode has a high efficiency and, thereby, may generate high light powers while utilizing small quantities of electrical energy.

Preferably, the LIDAR receiver unit also includes a control unit. The control unit is preferably configured for illuminating the detector surface for a predefined period of time with the aid of the test-light illumination unit. Additionally, the control unit is preferably configured for detecting a count rate of each pixel of the detector surface during the predefined period of time. Finally, the control unit is configured for recognizing a defect of a pixel when the count rate is lower than a predefined value. Therefore, a self-test of the detector surface may also be carried out on the basis of the test-light illumination unit. Therefore, in particular, an aging state of the detector surface may be ascertained, in order to therefore estimate a power of an entire LIDAR sensor. Therefore, a LIDAR sensor including an appropriate LIDAR receiver unit may also be continuously tested over its entire life cycle with respect to its performance. This test may be easily and with little complexity carried out by the described LIDAR receiver unit.

In one preferred embodiment of the present invention, the LIDAR receiver unit is a rotating receiver unit, in which the detector surface is situated on a rotor. Therefore, the detection surface is rotatable about a rotor axis. A predefined angular range of the rotation represents a dead zone. In the dead zone, a detection of the surroundings by the detector surface is prevented, for example, because the detector surface in the dead zone is oriented toward a housing part, which therefore prevents a view of the surroundings. The predefined period of time, in which the control unit carries out a test of the detector surface as described above, therefore advantageously corresponds to that period of time of the rotation, at which the detector surface is located in the dead zone. Therefore, a test of the detector surface may be cyclically carried out, without this having an effect on an operation of the LIDAR sensor or the LIDAR receiver unit. Alternatively to the above-described placement, the detector surface may also be stationary, only one mirror being fastened at the rotor. In this case, the mirror is configured for deflecting light from the surroundings onto the detector surface.

Finally, the present invention relates to a LIDAR sensor. In accordance with an example embodiment of the present invention, the LIDAR sensor includes a laser light source for illuminating the surroundings of the LIDAR sensor. In addition, the LIDAR sensor includes a LIDAR receiver unit as described above. The LIDAR receiver unit is utilized for detecting the light emitted from the laser light source and reflected by the surroundings. Due to the above-described advantageous embodiment of the LIDAR receiver unit, tests of the LIDAR sensor may therefore be easily and with little complexity carried out.

### BRIEF DESCRIPTION OF THE DRAWINGS

Exemplary embodiments of the present invention are described in detail below with reference to the figures.

FIG. 1 shows a schematic view of a LIDAR sensor according to one exemplary embodiment of the present invention.

FIG. 2 shows a schematic view of a first alternative of a LIDAR receiver unit of the LIDAR sensor according to the exemplary embodiment of the present invention.

FIG. 3 shows a schematic view of a second alternative of the LIDAR receiver unit of the LIDAR sensor according to the exemplary embodiment of the present invention.

FIG. 4 shows a schematic view of a third alternative of the LIDAR receiver unit of the LIDAR sensor according to the exemplary embodiment of the present invention.

FIG. 5 shows a schematic view of a fourth alternative of the LIDAR receiver unit of the LIDAR sensor according to the exemplary embodiment of the present invention.

### DETAILED DESCRIPTION OF EXAMPLE EMBODIMENTS

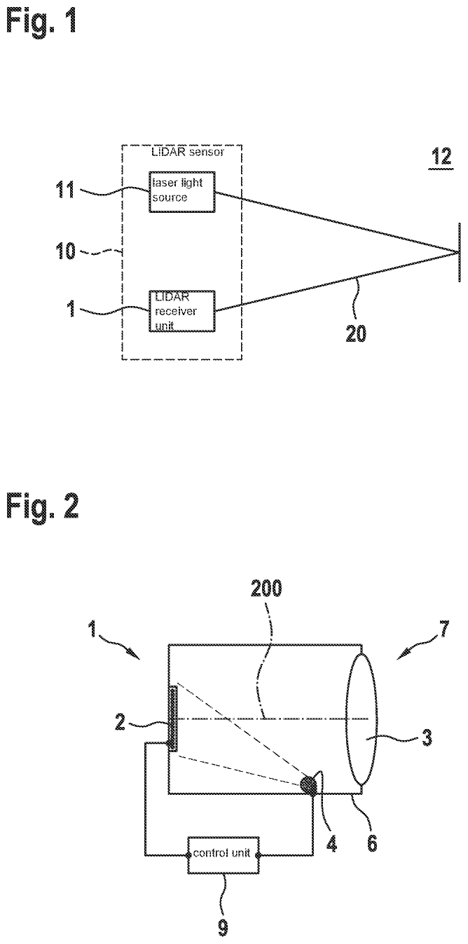

FIG. 1 schematically shows a LIDAR sensor 10 according to one exemplary embodiment of the present invention. LIDAR sensor 10 includes a laser light source 11, which is designed for emitting laser light. Therefore, surroundings 12 of LIDAR sensor 10 may be illuminated with the aid of laser light 20.

If laser light 20 is reflected by objects in surroundings 12, this may be detected by a LIDAR receiver unit 1 of LIDAR sensor 10. LIDAR receiver unit 1 is therefore designed for detecting laser light 20 reflected in surroundings 12.

LIDAR sensor 10 is advantageously provided as a surroundings sensor of a vehicle traveling in an automated or autonomous manner. Such a sensor therefore plays an important role in the object recognition and, thereby, the obstacle recognition of vehicles traveling in an automated or autonomous manner. Appropriate LIDAR sensors 10 are therefore subjected to multiple function tests, a regular self-test also being advantageous. Therefore, output power of laser light source 11 is, in particular regularly, ascertained. LIDAR sensor 10 according to the exemplary embodiment of the present invention allows for a simple and reliable self-testing and the execution of function tests.

FIG. 2 schematically shows a first alternative of receiver unit 1 of LIDAR sensor 10. LIDAR receiver unit 1 includes a detector surface 2, which is designed for detecting laser light 20. A test-light illumination unit 4 is situated in a fixed manner in relation to detector surface 2. Test-light illumination unit 4 is utilized for illuminating entire detector surface 2 with the aid of a test light, as the result of which background light is simulatable. Therefore, function tests of LIDAR receiver unit 1 may be carried out, which permit highly realistic simulations of basic parameters. In particular, the background illumination plays a large role in the real utilization of LIDAR sensor 1 for measuring purposes. Since this is usually generated by sunlight, an appropriate background illumination simulation in test set-ups is often difficult to implement, such a simulation of the background illumination being easily and with little complexity possible with the aid of test-light illumination unit 4. Therefore, reliable function tests of LIDAR receiver unit 1 may be carried out.

In the exemplary embodiment shown in FIG. 2, LIDAR receiver unit 1 includes a housing 6, which includes an opening 7.

Detector surface 2 as well as test-light illumination unit 4 is located at housing 6. Due to the particular location at housing 6, in particular, the above-described, fixed location of detector surface 2 and test-light illumination unit 4 may be achieved.

Via opening 7, detector surface 2 may detect surroundings 12, so that laser light 20 is detectable by detector surface 2. Particularly advantageously, at least one optical element 3, particularly preferably an objective lens, is located in opening 7. Due to the at least one optical element 3, surroundings 12 may be imaged onto detector surface 2.

Via a control unit 9, test-light illumination unit 4 may be activated on the one hand; on the other hand, each pixel of detector surface 2 may be read out. In this way, in particular, a background light simulation may be carried out for test purposes, in that test-light illumination unit 4 illuminates detector surface 2. For this purpose, test-light illumination unit 4 is designed for deflecting test light directly onto detector surface 2, i.e., in particular without additional reflections and without illuminating other components of LIDAR receiver unit 1. Therefore, only little light powers are to be generated by test-light illumination unit 4. Test-light illumination unit 4 may therefore be easily and cost-effectively implemented, for example, by a light-emitting diode.

With the aid of test-light illumination unit 4, in addition, an aging process of detector surface 2 may be monitored, so that a performance of LIDAR sensor 1 may be ascertained over its entire service life. This may be implemented, in that control unit 9 activates test-light illumination unit 4 for testing purposes for a predefined period of time and, thereby, illuminates detector surface 2 for the aforementioned predefined period of time. Thereafter, a count rate of each pixel of detector surface 2 is determined by test-light illumination unit 4 during the predefined period of time. During this time, test-light illumination unit 4 preferably emits the same quantity of light to each pixel of detector surface 2. If the count rate of a pixel is below a predefined value, control unit 9 may recognize a defect of this pixel.

Test-light illumination unit 4 therefore allows not only for the simulation of background light in function test scenarios, but additionally the ascertainment of an aging and/or of any other defect of detector surface 2. Therefore, LIDAR sensor 10 may also be particularly advantageously utilized for application-critical cases such as, in particular, in vehicles traveling in an automated or autonomous manner.

Test-light illumination unit 4 is located between the particular positions of detector surface 2 and optical element 3 with respect to an optical axis 200, which extends from optical element 3 to detector surface 2. Test-light illumination unit 4 is laterally offset with respect to optical axis 200, so that a light path between optical element 3 and detector surface 2 is not blocked. In this way, test-light illumination unit 4 is present in a close spatial arrangement with respect to detector surface 2, but does not interfere with the normal measuring operation of LIDAR receiver unit 1. Therefore, test-light illumination unit 4 may always be activated when this is required, no effect by test-light illumination unit 4 being present during the normal measuring operation of LIDAR receiver unit 1.

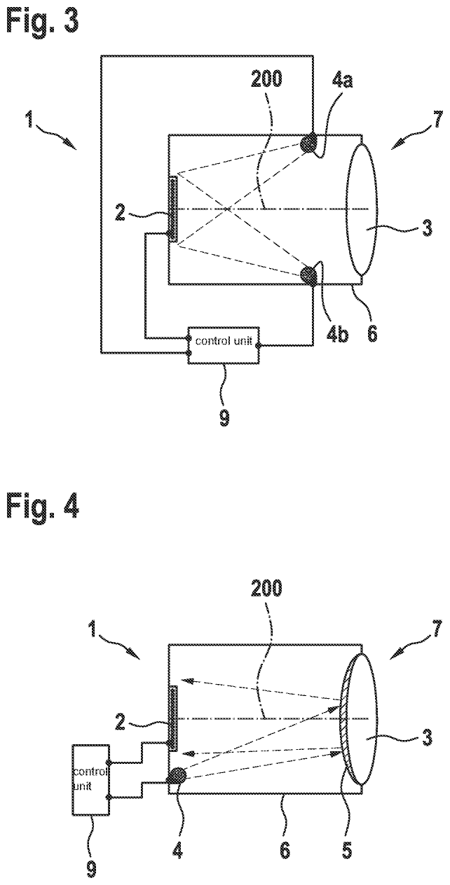

FIG. 3 schematically shows a second alternative of LIDAR receiver unit 1. In contrast to the first alternative, only the number of utilized light sources for test-light illumination unit 4 is different. Test-light illumination unit 4 in the second alternative includes two individual light sources 4a, 4b. These are distributed at different positions around the detector surface and are designed for illuminating detector surface 2 from different directions. In this way, a homogeneous light distribution on detector surface 2 may be achieved when detector surface 2 is illuminated by test-light illumination unit 4. Alternatively to the two individual light sources 4a, 4b, more than two individual light sources 4a, 4b may also be present, which are advantageously regularly distributed around detector surface 2.

In FIG. 4, a third alternative of LIDAR receiver unit 1 is shown. In the third alternative, due to test-light illumination unit 4, no direct, but rather an indirect illumination of detector surface 2 takes place. For this purpose, test-light illumination unit 4 emits the light in the direction of optical element 3, optical element 3 being designed for illuminating detector surface 2 by reflecting the light emitted by test-light illumination unit 4. Due to this reflection, a homogeneous distribution of the illumination and, thereby, a homogeneous light distribution on detector surface 2 takes place.

Preferably, the at least one optical element 3 includes an anti-reflection coating 5 at least on the side facing detector surface 2, aforementioned anti-reflection coating 5 being effective, in particular, only for laser light 20. A wavelength of the light emitted by test-light illumination unit 4 is advantageously different from the wavelength, for which anti-reflection coating 5 is effective. Therefore, only reflections of laser light 20 within housing 6 are minimized by anti-reflection coating 5, whereas test-light illumination unit 4 is not affected by anti-reflection coating 5.

In FIG. 4, only one light source of test-light illumination unit 4 is shown. Similarly to FIG. 3, multiple individual light sources 4a, 4b may also be present here, which jointly illuminate the at least one optical element 3, in order to implement an illumination of detector surface 2 with the aid of reflection at optical element 3.

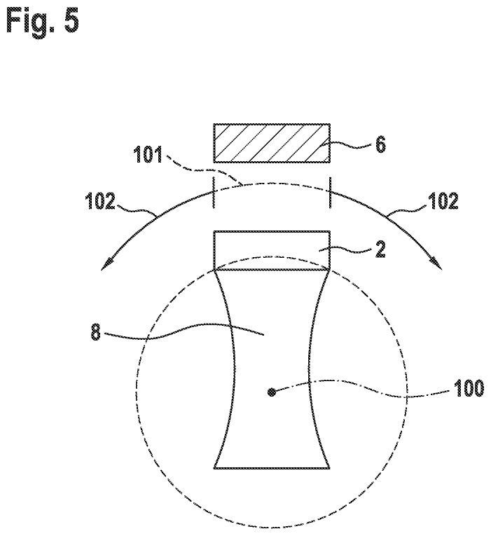

Finally, FIG. 5 shows a fourth alternative of LIDAR receiver unit 1. In FIG. 5, it is shown that LIDAR receiver unit 1 is a rotating unit, laser light source 1 of LIDAR sensor 10 preferably also being designed to be rotating. A rotation axis 100 is provided, about which detector surface 2 may rotate. For this purpose, detector surface 2 is mounted at a rotor 8. Particularly advantageously, laser light source 11 is also mounted at aforementioned rotor 8. Alternatively, only one mirror is mounted at rotor 8, and detector surface 2 and laser light source 11 are stationary. In this case, the mirror reflects the light emitted by laser light source 11 or the light extending to detector surface 2.

If detector surface 2 rotates about rotation axis 100, a dead zone 101 is present, in which a detection of surroundings 12 is prevented. The reason therefor is that the angular range of the rotary motion associated with dead zone 101 is spatially situated in such a way that, in this case, detector surface 2 is oriented toward a housing part 6 and, thereby, may not detect surroundings 12. The remaining angular range of the rotation represents a measuring range 102, in which a measurement with the aid of detector surface 2 is made possible by detecting laser light 20.

In FIG. 5, control unit 9 is not shown, for the sake of clarity, although it is present. It is provided that control unit 9 may carry out a self-test as described above, in that detector surface 2 is illuminated by test-light illumination unit 4 (also not shown in FIG. 5, for the sake of simplicity, but fixedly situated with respect to detector surface 2 as described above). An appropriate illumination takes place, in particular, in the period of time, in which detector surface 2 is located in dead zone 101. In this zone, the aforementioned may be carried out by control unit 9, in that a defect of individual pixels may be inferred on the basis of the count rate of the particular pixels of detector surface 2. Of course, test-light illumination unit 4 may also be utilized in the fourth alternative as described above for simulating background light in other function tests.

In all alternatives, it is particularly advantageously provided that test-light illumination unit 4 is designed to be dimmable and, thereby, may emit light in different intensities. In this way, an intensity of the background light illumination is adjustable, so that simulations are made possible using various background light intensities. Therefore, test-light illumination unit 4 permits flexible and comprehensive tests to be carried out.

What is claimed is:

1. A LIDAR receiver unit for detecting laser light in surroundings of the LIDAR receiver unit, the LIDAR receiver unit comprising:
a detector surface; and
a test-light illumination unit immovably situated with respect to the detector surface, the test-light illumination unit being configured to illuminate the detector surface to simulate background light.

2. The LIDAR receiver unit as recited in claim 1, further comprising:
at least one optical element, the optical element configured to image the surroundings onto the detector surface, a position of the test-light illumination unit being situated between a particular position of the detector surface and the optical element with respect to an optical axis extending from the optical element to the detector surface.

3. The LIDAR receiver unit as recited in claim 2, wherein the test-light illumination unit is configured to illuminate the at least one optical element, the optical element being configured to reflect light of the test-light illumination unit and, thereby, illuminate the detector surface with the light of the test-light illumination unit.

4. The LIDAR receiver unit as recited in claim 3, wherein the at least one optical element includes an anti-reflection coating on a side facing the detector surface, a wavelength, for which the anti-reflection coating is effective, being different from a wavelength of the light emitted by the test-light illumination unit.

5. The LIDAR receiver unit as recited in claim 1, wherein the test-light illumination unit is configured to directly illuminate the detector surface.

6. The LIDAR receiver unit as recited in claim 1, further comprising:
a housing in which the detector surface is situated and at which the test-light illumination unit is fastened, the housing including an opening through which the laser light from the surroundings is detectable by the detector surface.

7. The LIDAR receiver unit as recited in claim 1, wherein the test-light illumination unit includes multiple individual light sources which are situated at different positions around the detector surface and are configured to illuminate the detector surface from different directions relative to one another.

8. The LIDAR receiver unit as recited in claim 1, wherein the test-light illumination unit is dimmable.

9. The LIDAR receiver unit as recited in claim 1, wherein the test-light illumination unit includes at least one light-emitting diode.

10. The LIDAR receiver unit as recited in claim 1, further comprising:
a control unit configured to:
illuminate the detector surface using the test-light illumination unit for a predefined period of time;
ascertain a count rate of each pixel of the detector surface during the predefined period of time; and
recognize a defect of a pixel when the count rate is less than a predefined value.

11. The LIDAR receiver unit as recited in claim 10, wherein the detector surface or a mirror which deflects light to the detector surface, is situated on a rotor and is rotatable about a rotation axis, a predefined angular range of a rotation representing a dead zone in which a detection of the surroundings is prevented, and the predefined period of time corresponds to that period of time of the rotation, at which the detector surface or the mirror is located in the dead zone.

12. A LIDAR sensor, comprising:
a laser light source configured to illuminate surroundings of the LIDAR sensor; and
a LIDAR receiver unit configured to detecting light emitted by the laser light source and reflected by the surroundings, the LIDAR receiver unit including:
a detector surface, and
a test-light illumination unit immovably situated with respect to the detector surface, the test-light illumination unit being configured to illuminate the detector surface to simulate background light.
